(19) United States
(12) Patent Application Publication
(10) Pub. No.: US 2024/0392565 A1
(43) Pub. Date: Nov. 28, 2024

(54) METHOD OF MANUFACTURE AND USE OF OSB WITH EXTRUDED POLYMER BANDS

(71) Applicant: LOUISIANA-PACIFIC CORPORATION, NASHVILLE, TN (US)

(72) Inventor: JARROD KEVIN LINE, BRENTWOOD, TN (US)

(21) Appl. No.: 18/795,330

(22) Filed: Aug. 6, 2024

Related U.S. Application Data
(63) Continuation-in-part of application No. 17/992,046, filed on Nov. 22, 2022, now Pat. No. 12,054,945.
Application No. 17/992,046 is a continuation of application No. 16/412,599, filed on May 15, 2019, now Pat. No. 11,505,942.
(60) Provisional application No. 62/671,508, filed on May 15, 2018.

(51) Int. Cl. E04C 2/24; B27K 3/08; E04B 1/86; E04C 2/12

(52) U.S. Cl. CPC E04C 2/243; B27K 3/08; E04B 1/86; E04C 2/12

(57) ABSTRACT

A system for introducing a noise-dampening polymer in-line in the manufacturing process of a manufactured wood product to achieve higher acoustic performance in siding, sheathing, roofing, flooring, and similar applications using the manufactured wood product. Several lines or bands of the noise-dampening polymer are deposited transversely across one side or face of the product. The polymer is deposited where the product is expected to contact joists or studs. The polymer may also be deposited on contact joists or studs. The polymer may be a viscoelastic polymer.

This application is a continuation-in-part of U.S. patent application Ser. No. 17/992,046, filed Nov. 22, 2022, which is a continuation of U.S. patent application Ser. No. 16/412,599, filed May 15, 2019, which claims benefit of and priority to U.S. Provisional App. No. 62/671,508, filed May 15, 2018, both of which are incorporated herein in their entireties by specific reference for all purposes.

### FIELD OF INVENTION

This invention relates to a method and system for manufacturing wood products (such as OSB, oriented strand board) with acoustic dampening polymer bands.

### BACKGROUND OF THE INVENTION

Acoustic comfort is important in building design. Noise is the often the primary complaint by home owners in residential single-family homes, and noise reduction also is an important performance criterion in multi-family and commercial construction (particularly in the healthcare and education segments). Airborne noise/STC (Sound Transmission Class) rating and impact noise (Impact Insulation Class, IIC) rating in wall and floor or ceiling assemblies often is specified in codes and standards by ANSI, IgCC and LEED.

Airborne noise from outside or inside the living space has been addressed with various field-applied and pre-fabricated noise dampening constructions products, such as resilient channels, clips, staggered studs, multiple layers of drywall, wall cavity insulation, and laminated acoustic drywall. In flooring, wall, and ceiling structures, “resilient channels” are often used (and are required in some types of constructions), which reduce the transmission of airborne sound by placing or suspending a material from a stud or joint. However, there are no building materials, such as OSB-based siding, sheathing, roofing or flooring, that apply a sound dampening material in the primary manufacturing process of panels with improved acoustic performance.

### BRIEF DESCRIPTION OF THE DRAWINGS

FIG. 1 shows a view of an OSB panel with lines or bands of sound-dampening polymer in accordance with an embodiment of the present invention.

FIG. 2 shows a cutaway view of the OSB panel of FIG. 1 being installed as a flooring panel.

FIG. 3 shows an embodiment of a robotic polymer or plastic extruder device.

FIG. 4 shows a cutaway view of the OSB panel of FIG. 1 being installed as a flooring panel on studs with lines or bands of sound-dampening polymer in accordance with another embodiment of the present invention.

FIG. 5 shows a cutaway view of the OSB panel of FIG. 1 with a missing line or band of sound-dampening polymer being installed as a flooring panel on studs with one corresponding stud with a line or band of sound-dampening polymer in accordance with another embodiment of the present invention.

FIG. 6 shows a cutaway view of the OSB panel of FIG. 1 being installed as a flooring panel on studs with an irregularly-spaced or offset stud with a line or band of sound-dampening polymer in accordance with another embodiment of the present invention.

FIG. 7 shows a cutaway view of an OSB panel being installed as a flooring panel on studs with lines or band of sound-dampening polymer in accordance with another embodiment of the present invention.

### DETAILED DESCRIPTION OF EXEMPLARY EMBODIMENTS

In various exemplary embodiments, the present invention comprises a method or process for manufacturing wood products with acoustic dampening properties. The manufactured wood products include, but are not limited to, oriented strand board (OSB), laminated strand lumber (LSL), medium-density fiberboard (MDF), particleboard, or various similar wood composites.

In several embodiments, the present invention comprises a system for introducing a noise-dampening polymer in-line in the manufacturing process of a manufactured wood product to achieve higher acoustic performance (e.g., Sound Transmission Class-STC and/or Impact Insulation Class-IIC rating) in siding, sheathing, roofing, flooring, and similar applications using the manufactured wood product. The polymer may be a viscoelastic polymer.

Several lines or bands of the noise-dampening polymer are deposited transversely across one side or face of the product (e.g., OSB panel). The polymer is deposited where the product is expected to contact joists or studs. Accordingly, in several embodiments the polymer lines or bands are applied on the side/face of the product opposite nail lines, which typically are indicated or marked on the outward or upward facing side of the panel.

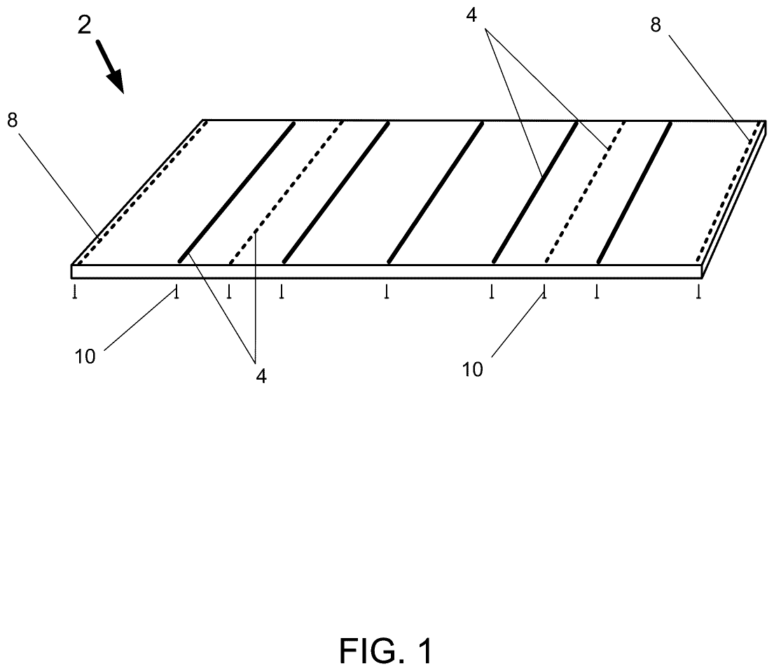

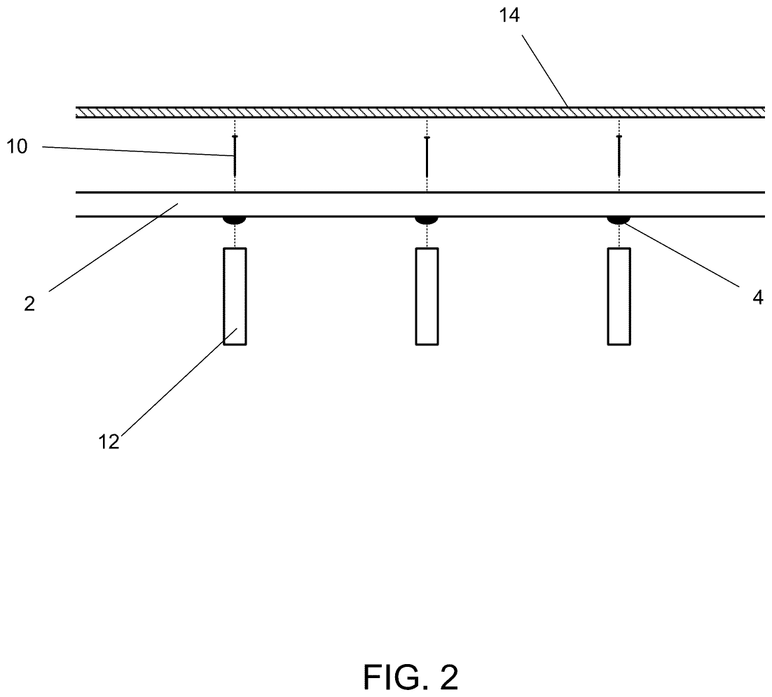

FIG. 1 shows an example of a bottom face of an OSB panel 2 with lines of sound dampening polymer 4 applied at multiples of 16 inches, 24 inches, and 48 inches from an edge (parallel to the polymer lines), as well as along each corresponding edge 8 of the panel. This arrangement is beneficial as the edges of the OSB panel are typically lined up with underlying floor joists during construction, with intervening joists typically spaced every 16, 24 or 48 inches. When installed, the corresponding sound dampening polymer lines rest on top of the joists, acting as a sound dampening barrier between the panel and the joists (i.e., the polymer application along the face opposite the nail lines provides dampening material in the areas of the interface with the floor joists, as nails 10 are applied during construction to secure the OSB panel 4 to the joists 12, as seen in FIG. 2). An overlay 16, such as carpet, tile or other floor covering known in the art, may then be added over the installed OSB panel subflooring.

When multiple polymer lines are applied at variable spacing, as seen in FIG. 1, only the polymer lines that correspond to particular joist spacing will be in contact with a joist or joists. The remaining lines essentially are unused, although they may provide some benefit if in contact with cross-joints or end members. In alternative embodiments, a product may be produced with polymer lines at set spacing intervals, so that a user would select the product with appropriately-spaced lines for use based on the joist spacing.

The polymer may be heat cured or hot melt (i.e., thermoplastic). In one embodiment, the polymer is applied post-press on the main manufacturing line, or through a post-application process off-line. The lines or bands can be continuous, or intermittent (i.e., dots or streaks) (examples of both types of lines are shown in FIG. 1), and may be applied with overhead linear applications or sprayers. In some additional embodiments, additional polymer may be added in-between the standard spaced lines (as described above). The additional polymer may help in providing a sound barrier in cases where joists are not straight or are misaligned.

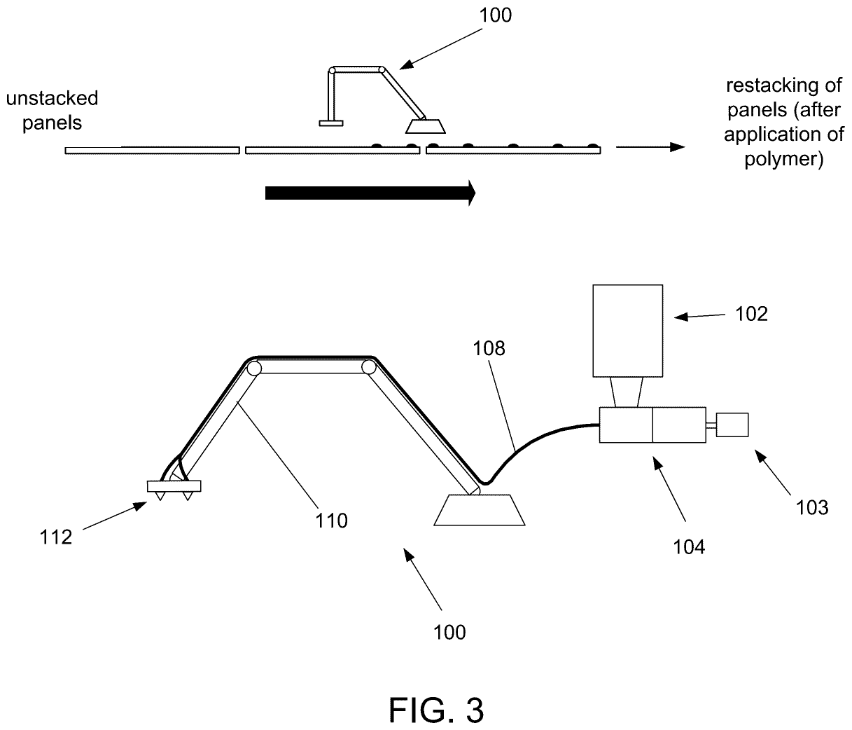

FIG. 3 shows a multi-axis robotic device 100 suitable for in-line use for application of the polymer to unstacked panels. Low cost injection molded plastics (e.g., HDPE, LDPE, PP, and so on) are fed in bead or spherical form from a bead hopper 102 into a heating element in an injection molding mechanism 104, and then extruded by means of a motor-driven 103 screw. The liquefied plastic travels through a heat-traced, heat-jacketed, flexible, high-pressure tube(s) or line(s) 108 disposed on a multi-axis robotic arm 110 to an extruder nozzle or nozzles 112 at the end of the arm system.

The extruder nozzles can range in size from 1 mm to 20 mm (e.g., orifice size), and can apply a variety of thickness, widths and patterns to the panel. It should be noted that while this device can be used to apply the bands or lines as described above, it also be used to more flexibly apply polymer features to wood joists, studs, boards, or other panel products or substrates (e.g., ventilated siding, acoustic OSB, and the like) for a variety of purposes.

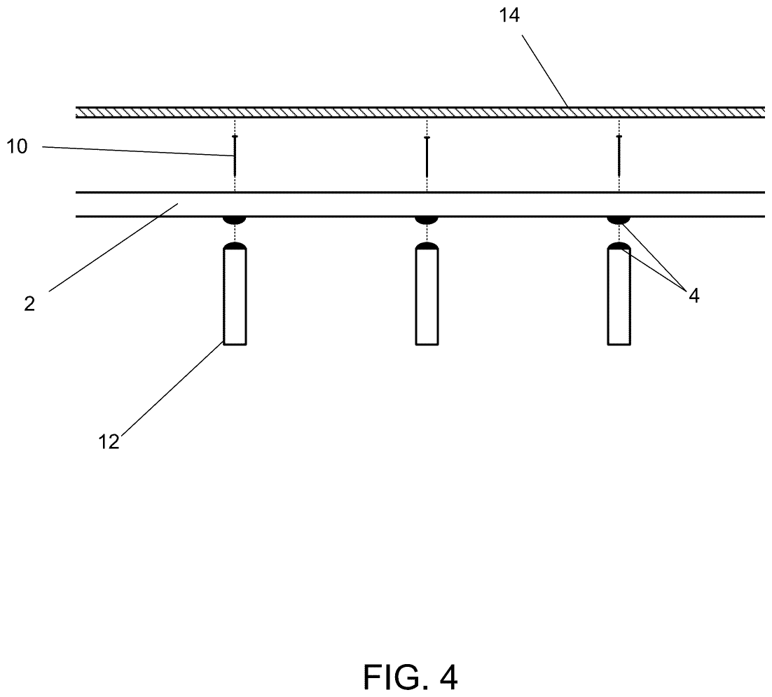

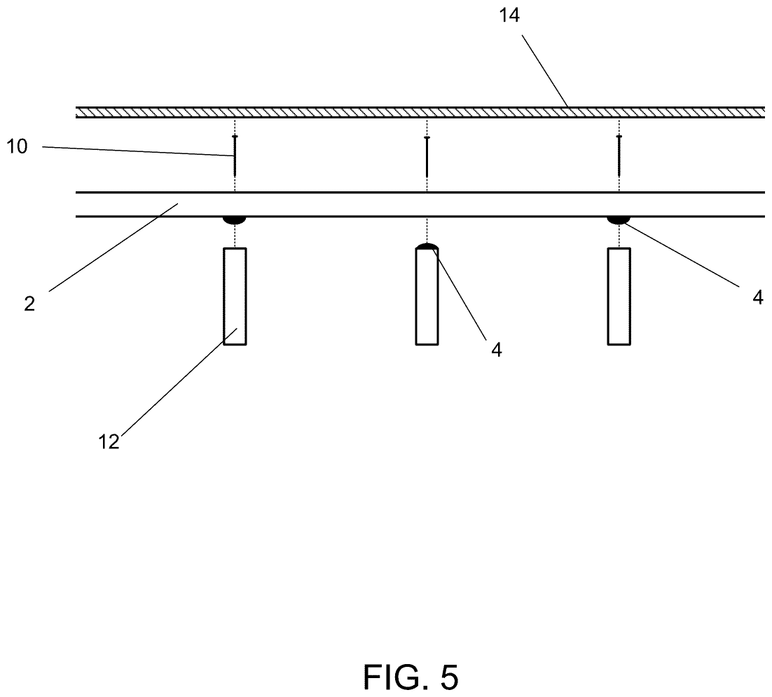

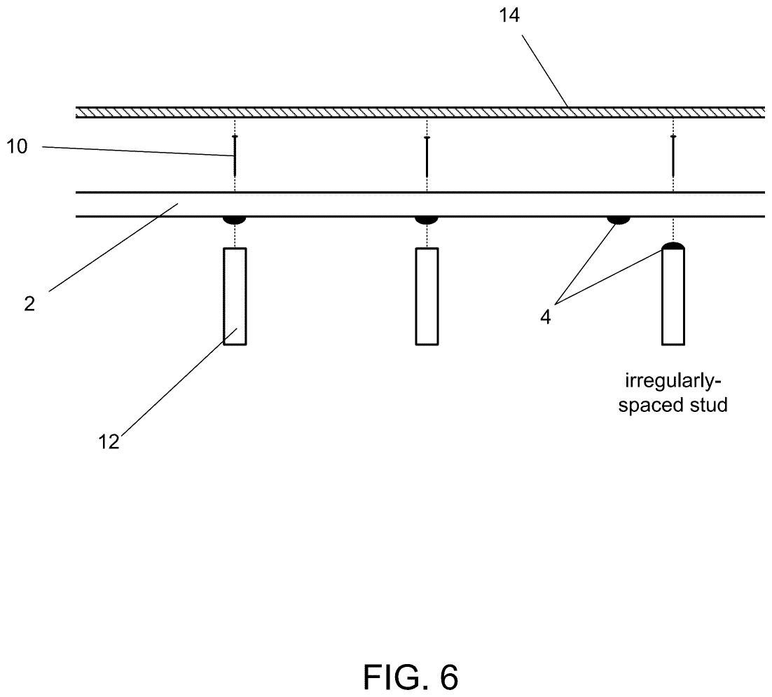

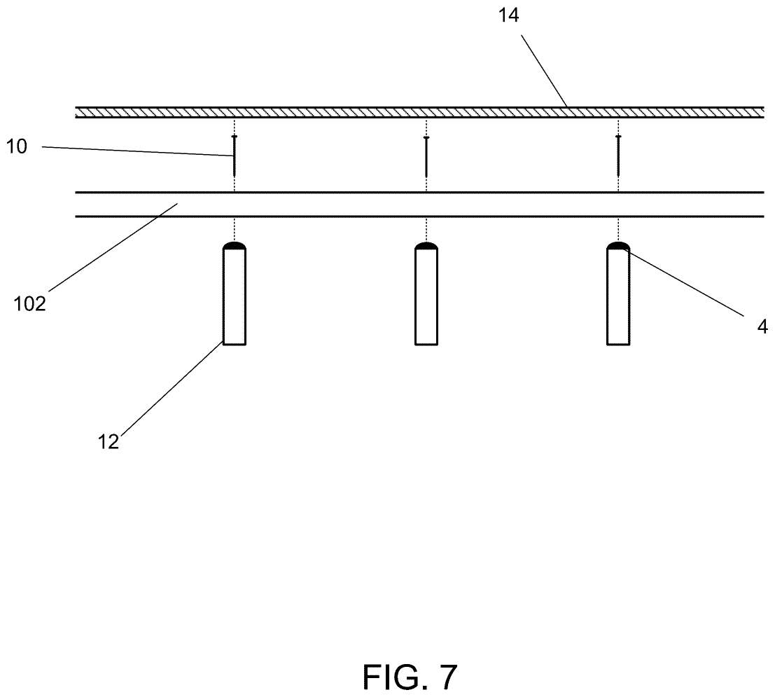

In alternative embodiments, several lines or bands of the noise-dampening polymer may be deposited longitudinally along the contact joists or studs, in addition to or in place of depositing said noise-dampening polymer on the side/face of the panel. The deposition of the contact joists or studs may be used in applications where it is important to ensure that a sound barrier be as complete as possible (i.e., present along all or most contact points). Thus, noise-dampening polymer may be deposited on some or all of the joists or studs as well as on the side/face of the panel, as seen in FIG. 4, and may extend for some or all of the length of a joist or stud. Noise-dampening polymer may be deposited on joints or studs where noise-dampening polymer is missing or damaged along the corresponding area of the side/face of the panel, as seen in FIG. 5. Noise-dampening polymer may be deposited on offset or misaligned joints or studs (e.g., irregular or non-standard spacing) where noise-dampening polymer is not present along the corresponding area of the side/face of the panel, as seen in FIG. 6. Noise-dampening polymer also may be deposited on some or all of the joints or studs where a panel with noise-dampening polymer (as described above) is not available or cannot be used, and a panel 102 without noise-dampening polymer is used, as seen in FIG. 7.

Accordingly, in several embodiments the polymer lines or bands (continuous or intermittent) are applied on the side/face of the product opposite nail lines, which typically are indicated or marked on the outward or upward facing side of the panel. Polymer lines or bands also may be applied on the top edge or side of joints or studs when needed or otherwise appropriate. Joists or studs may be provided with pre-applied or factory-applied polymer lines or bands (continuous or intermittent) as described above, or the polymer lines or bands (continuous or intermittent) may be applied in the field during installation, such as with a trowel, gun, or other form of applicator.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for installing a manufactured wood product to create a sound dampening barrier, comprising:
a noise-dampening polymer affixed in a plurality of locations on a top edge of a plurality of contact joists or studs;
a manufactured wood product with a first edge, a second, a front face, and a back face;
wherein the manufactured wood product is affixed to the plurality of contact joists or studs such that noise-dampening polymer is in contact with the back face of the manufactured wood product.

2. The system of claim 1, further comprising a second noise-dampening polymer pre-affixed in a second plurality of locations on the back face of the manufactured wood product, wherein the plurality of locations are spaced at a series of pre-determined distances from the first edge of the manufactured wood product and each other.

3. The system of claim 2, wherein the second plurality of locations comprise a first location proximate the first edge, and a second location proximate the second edge of the manufactured wood product, wherein the second edge is opposite and parallel to the first edge.

4. The product of claim 1, wherein the polymer is applied in a continuous line in at least one of the plurality of locations.

5. The product of claim 1, wherein the polymer is applied intermittently in at least one of the plurality of locations.

6. The product of claim 1, wherein the polymer is applied intermittently in at least one of the plurality of locations.

7. The product of claim 1, wherein the polymer is applied in a line in at least two of the plurality of locations.

8. The product of claim 4, wherein the line is parallel to a longitudinal axis of the corresponding contact joist or stud.

9. The product of claim 2, wherein the pre-determined distances are spaced at multiples of 16 inches, 24 inches, and/or 48 inches from the first edge of the manufactured wood product.

10. The product of claim 2, wherein said spacing is selected based on a corresponding spacing of the contact joists or studs.

11. The product of claim 1, wherein the polymer comprises a viscoelastic polymer.

12. The product of claim 2, wherein the second polymer is heat cured or hot melt.
